(19) United States
(12) Patent Application Publication
(10) Pub. No.: US 2014/0212615 A1
(43) Pub. Date: Jul. 31, 2014

(54) MULTI-LAYERED MULTIPLE-LABEL PRINTABLE COMPOSITE FORM

(71) Applicant: ASSOCIATION OFFICE SUPPLY, INC. d/b/a Versiprint, Edmonds, WA (US)

(72) Inventors: Larry David Norgaard, Edmonds, WA (US); Susan Schiller Norgaard, Edmonds, WA (US)

(21) Appl. No.: 13/794,438

(22) Filed: Mar. 11, 2013

Related U.S. Application Data
(60) Provisional application No. 61/759,337, filed on Jan. 31, 2013.

(51) Int. Cl. B42D 5/02; B42D 5/00

(52) U.S. Cl. CPC B42D 5/027; B42D 5/001
USPC 428/42.1; 428/43; 283/66.1; 156/268

(57) ABSTRACT

A multi-purpose form with a plurality of label types on a single business form includes an adhesive-backed label, a label with a front-facing exposed adhesive, and labels which can form laminated water-resistant tags. The business form has a plurality of layers. The form includes die cuts which allow for layers to be peeled away from the form, exposing adhesive layers and forming the different label types.

### CROSS-REFERENCE TO RELATED APPLICATIONS

This application claims the priority benefit to U.S. Provisional Application No. 61/759,337, filed Jan. 31, 2013 the entire disclosure of which is hereby incorporated by reference in its entirety and should be considered a part of this specification.

### BACKGROUND

1. Field of the Invention

The present disclosure generally relates to printable forms and more particularly, to an improved multi-layered adhesive-lined form and methods of making the same.

2. Description of the Related Art

Previous printable business forms containing adhesive-lined labels have been limiting. Prior forms were expensive to manufacture, required complex processing and typically only contained a single type of adhesive-lined label on the form. For example, prior forms contained labels that had adhesive formed on the back of the label. The forms either had a removable backing to expose the adhesive behind the label or had a section of the front face which was removable to expose a front-facing adhesive. However, such printable forms only contained one type of label.

### SUMMARY

In view of the foregoing, there is a need for a multi-purpose form that can include a plurality of types of labels on a single business form. Such a form would be able to contain labels with a back-facing exposed adhesive behind the label, contain labels with a front-facing exposed adhesive and contain labels forming a laminated water-resistant tag. There is also a need for a multi-purpose form with printable areas that can be processed through a household printer. Additionally, there is a need for a composite business form which can include a plurality of types of labels that can be mass manufactured at a low cost.

Accordingly, disclosed herein is multi-layered multi-purpose printable composite business form. According to some embodiments described herein, the arrangement includes three different types of labels including a first type having an adhesive-backed label, a second type having an exposed peripheral outer edge front-facing adhesive, and a third type having a laminated water-resistant tag.

In accordance with one embodiment, a composite business form has plurality of layers including a face layer, a first adhesive layer, a release layer, a second adhesive layer, and a backing layer. The face layer is positioned as the top layer and has pre-printed information and a printable area juxtaposed against borders or other non-printable regions. A first adhesive layer and a second adhesive layer are positioned on the top and bottom of a release layer. A backing layer is positioned behind the second adhesive layer and, in one embodiment, is a clear or transparent sheet. The composite business form has at least one front-side die cut forming an outer peripheral edge and a die cut area lying within the outer peripheral edge. In one embodiment, the front-side die cut can is cut to a depth such that the cut can extend through the face layer and the first adhesive layer, but does not extend through the release layer and/or does not penetrate the release layer, in order to form a peel-able adhesive-backed label within the die cut area. In accordance with another embodiment, the front-side die cut can be cut to a depth such that the cut can extend through the face layer, the first adhesive layer, and the release layer, but does not extend through the second adhesive layer and/or does not penetrate the second adhesive layer. In such an embodiment, the second adhesive layer becomes exposed creating a front-facing adhesive label when the face layer, first adhesive layer and release layers of the outer peripheral edge are separated from the composite business form. In yet another embodiment, the composite business form has a front-side die cut forming a die cut area and a flap section. In such an embodiment, the front-side die cut can be cut to a depth such that the cut can extend through the face layer, the first adhesive layer, and the release layer, but does not extend through the second adhesive layer and/or does not penetrate the second adhesive layer. In such an embodiment, the face layer, the first adhesive layer, and the release layer are removably coupled with the second adhesive layer such that the second adhesive layer and backing layer are exposed on the flap section when the face layer, first adhesive layer, and release layer are removed. Once removed, the exposed adhesive flap can be folded on top of the die cut area to form a water-resistant tag.

In accordance with one embodiment, a method of forming an adhesive-backed label comprises printing and/or writing a plurality of symbols on the composite form and peeling the face layer and first adhesive layer away from the composite form to expose the first adhesive layer. In accordance with another embodiment, a method of forming a front-facing adhesive label comprises printing and/or writing a plurality of symbols on the composite form and peeling the face layer, first adhesive layer, and release layer of the outer peripheral edge section away from the composite form to expose the second adhesive layer. In accordance with yet another embodiment, a method of forming a water-resistant tag comprises printing and/or writing a plurality of symbols on the composite form, peeling the face layer, first adhesive layer, and release layer of the flap section away from the composite form to expose the second adhesive layer and backing layer, and folding the flap on top of the die cut area to form a water-resistant tag.

In accordance with another embodiment, a composite business form has plurality of layers including a face layer, adhesive layer with two or more separate sections of adhesive, and a backing layer. The composite business form has at least one front-side die cut forming an outer peripheral edge and a die cut area lying within the outer peripheral edge. In one embodiment, the front-side die cut can is cut to a depth such that the cut can extend through the face layer and one section of the adhesive layer, but does not extend through the backing layer and/or does not penetrate the backing layer, in order to form a peel-able adhesive-backed label within the die cut area. In accordance with another embodiment, the front-side die cut can be cut to a depth such that the cut can extend through the face layer, but does not extend through a section of the adhesive layer and/or does not penetrate the adhesive layer in order to create a front-facing adhesive label by exposing the adhesive layer on the peripheral edge when the face layer is separated from the composite form. In yet another embodiment, the composite business form has a front-side die cut forming a die cut area and a flap section. In such an embodiment, the face layer is removably coupled with a section of the adhesive layer such that the section of adhesive and backing layers are exposed on the flap section when the face layer is removed. Once removed, the exposed adhesive flap can be folded on top of the die cut area to form a water-resistant tag.

In accordance with one embodiment, a method of forming an adhesive-backed label comprises printing and/or writing a plurality of symbols on the composite form and peeling the face layer and first adhesive layer away from the composite form to expose a section of the adhesive layer. In accordance with another embodiment, a method of forming a front-facing adhesive label comprises printing and/or writing a plurality of symbols on the composite form and peeling the face layer of the outer peripheral edge section away from the composite form to expose a section of the adhesive layer. In accordance with yet another embodiment, a method of forming a water-resistant tag comprises printing and/or writing a plurality of symbols on the composite form, peeling the face layer of the flap section away from the composite form to expose a section of the adhesive layer and backing layer, and folding the flap on top of the die cut area to form a water-resistant tag.

In accordance with yet another embodiment, a composite business form has plurality of layers including a face layer, a release layer, an adhesive layer, and a backing layer. The composite business form has at least one front-side die cut forming an outer peripheral edge and a die cut area lying within the outer peripheral edge. In accordance with another embodiment, the front-side die cut can be cut to a depth such that the cut can extend through the face layer and the release layer, but does not extend through the adhesive layer and/or does not penetrate the adhesive layer. Such an embodiment forms a front-facing adhesive label by exposing the adhesive layer on the peripheral edge when the face layer and release layers are separated from the composite form. In yet another embodiment, the composite business form has a front-side die cut forming a die cut area and a flap section. In such an embodiment, the face layer and release layers are removably coupled with the adhesive layer such that the adhesive layer and backing layer are exposed on the flap section when the face layer and release layers are removed. Once removed, the exposed adhesive flap can be folded on top of the die cut area to form a water-resistant tag.

In accordance with one embodiment, a method of forming a front-facing adhesive label comprises printing and/or writing a plurality of symbols on the composite form and peeling the face layer and release layers of the outer peripheral edge section away from the composite form to expose the adhesive layer. In accordance with yet another embodiment, a method of forming a water-resistant tag comprises printing and/or writing a plurality of symbols on the composite form, peeling the face layer and release layers of the flap section away from the composite form to expose a section of the adhesive layer and backing layer, and folding the flap on top of the die cut area to form a water-resistant tag.

In accordance with one embodiment, the composite business form is a vehicle identification label for automobile dealers, with five labels including a deal jacket label, a stock window sticker, an inside window vehicle specification, and two key tag labels. The deal jacket label is a peel-able adhesive backed label and is placed on a vehicle's information folder. The outer peripheral edge of the face of the stock window sticker has a peel-off portion which exposes the front-facing adhesive layer underneath. The stock window sticker is placed on the inside of the window of a vehicle facing the exterior of the vehicle. The outer peripheral edge of the face of the inside window vehicle specification has a peel-off portion which exposes the front-facing adhesive layer underneath. The inside window vehicle is placed on the inside of the window of a vehicle facing the exterior of the vehicle. The key tags are waterproof tags to be placed on the key ring of the vehicle. A flap portion of the face of the key tag label has a peel-off portion to expose a clear plastic substrate layer with adhesive on front of the substrate. The clear plastic substrate layer is folded and placed on top of the face portion forming a laminated, waterproof tag.

### BRIEF DESCRIPTION OF THE DRAWINGS

FIG. 1 is a front view of a composite business form according to one embodiment.

FIG. 2 illustrates a partial cross-sectional view of the composite business form of FIG. 1 according to one embodiment.

FIG. 3 illustrates a partial cross-sectional view of the composite business form according to another embodiment.

FIG. 4A is a tag portion of the business form according to the embodiment of FIG. 1.

FIG. 4B is a tag portion of the business form with an exposed front-facing adhesive layer according to the embodiment of FIG. 1.

FIG. 4C is an assembled water-proof tag according to the embodiment of FIG. 1.

FIG. 5 is a back view of the composite business form according to one preferred embodiment.

### DETAILED DESCRIPTION

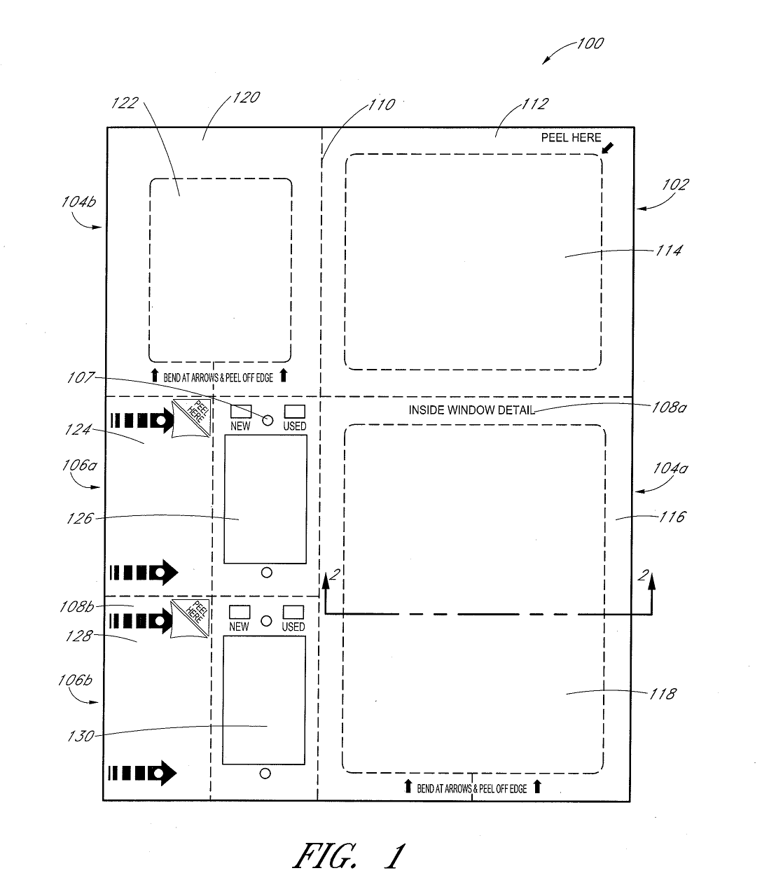

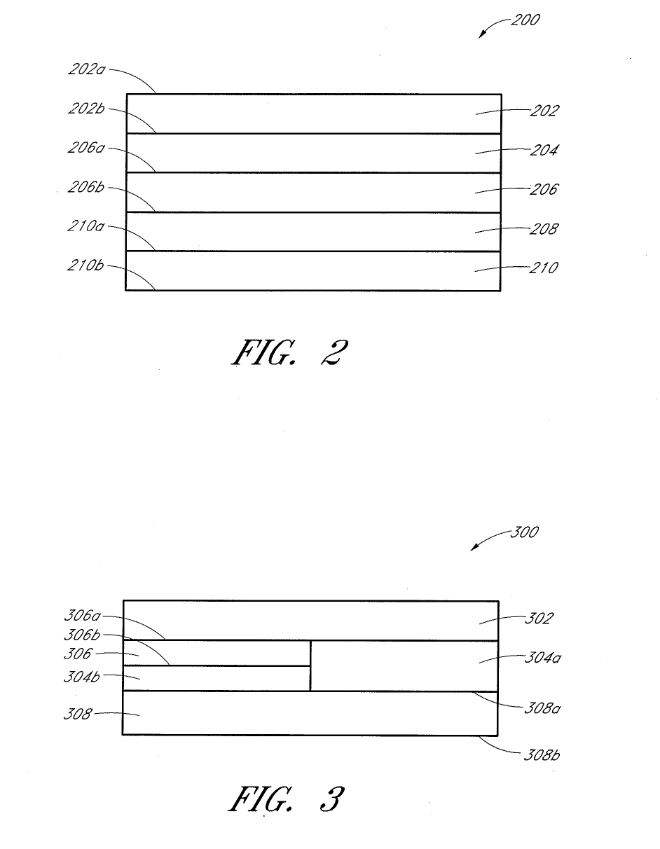

References will now be made to the drawings wherein like numerals refer to like parts throughout. FIG. 1 illustrates a front view of a composite business form 100 according to one embodiment. In the illustrated embodiment, the composite business form 100 can include a plurality of separable labels 102, 104a, 104b, 106a, 106b. As will be explained in more detail below, the illustrated form 100 is particularly useful in identifying, labeling and tracking separate components using a single printable form. The label 100 of FIG. 1 can include five labels 102, 104a, 104b, 106a, 106b, which together can form three types of labels. As will be described in more detail further below, the labels can include a first type 102 having an adhesive-backed label, a second type having an exposed peripheral outer edge front-facing adhesive 104a, 104b, and a third type having a laminated water-resistant tag 106a, 106b. Through holes 107 can be formed in the composite business form 100 using, for example, an air punch or die. The composite business form 100 can be die cut substantially along horizontal lines 108a, 108b and vertical line 110 creating a perforation such that labels 102, 104a, 104b, 106a, and 106b can be separable along the perforated cuts. In one embodiment the composite business form 100 can be rectangular and substantially 8.5 inches wide by 11 inches long. It should be appreciated that the embodiment shown in FIG. 1 is for illustration purposes and the composite business form can include a different number of label, labels of different shapes, and label types, combinations and sub-combinations and the sizing of the sheet and labels can be varied in modified embodiments. As will be depicted with reference to FIG. 2, the business form can include a plurality of layers.

FIG. 2 illustrates a partial cross-sectional view of the composite business form 100 along line A-A of FIG. 1 according to one embodiment. As depicted in FIG. 2, the form can include a face layer 202, a first adhesive layer 204, a release layer 206, a second adhesive layer 208, and a backing layer 210. It should be appreciated that the embodiment shown in FIG. 2 is for illustration purposes and the composite business form in other embodiments can include a different number of layers. The face layer 202 can be made out of any paper, cardstock, cloth or material as is known in the art that will accept variable imprinting by a printer (e.g., a standard household or office printer). In a modified embodiment, the face layer 202 can be made out of any material as is known in the art that will accept other forms of inscription such as etching, branding, carving or dying. The face layer 202 can include a front side 202a and a back side 202b. The front side can accept the variable print information. The back side of the face layer 202b can adhere to the first adhesive layer 204. As is illustrated in FIG. 1, the front side of the face layer 202a can include pre-printed information such as instructions on usage, trademark or copyright information, or decoration. The front side of the face layer 202a can also include printable areas 114, 118, 122, 126, 130 juxtaposed against borders 112, 116, 120 or other non-printable or pre-printed regions 124, 128 as depicted in FIG. 1. The size of the printable areas 114, 118, 122, 126, 130 can vary depending on the types of labels and the nature of the form. Details of the printable and pre-printed or non-printable regions will be discussed with reference to the individual label types discussed below. The printable area of the front side of the face layer 202 can be readily printed using a standard printer (e.g., household or business) such as an inkjet printer, laser printer or any other printer as is known in the art. The available printable area can be pre-programmed into a computer software program such that the printer does not print upon the non-printable or pre-printed areas on the front side of the face layer 202a. Using this method, a variety of form sizes can be easily selected by the user for printing.

In one embodiment, the first adhesive layer 204 can abut the back side of the face layer 202b such that the face layer 202 can cover and affix to the first adhesive layer 204. In such an embodiment, the top two layers of the composite business form can be a face layer with a printable front side surface 202a and a first adhesive layer 204 attached to the back side surface of the face layer 202b. As described in more detail below, when the subsequent layers 206, 208, 210 are removed, the top two layers 202, 204 can form a peel-off label with exposed adhesive on the back side of the label. In one preferred embodiment, the first adhesive layer 204 can be the same size in width and length as the face layer 202 such that the face layer has adhesive material covering the entire surface area of the back side of the face layer. In an alternative embodiment, the first adhesive layer 204 can have a surface area that can be smaller in width and length than the face layer 202 such that portions of the face layer do not have any adhesive affixed thereto. The adhesive formulation in the first adhesive layer 204 can form a permanent adhesive label, or alternatively, can form a removable adhesive label. The first adhesive layer 204 can be a permanent adhesive layer such that the label with adhesive is not intended to be removable after it is affixed to a surface. In a modified embodiment, the first adhesive layer 204 can be minimal residue adhesive such that the label with adhesive can be removed and/or reused on alternate surfaces without leaving noticeable adhesive residue on the original surface.

With reference to FIG. 2, the first adhesive layer 204 can be releasably coupled to a release layer 206. The release layer 206 can have a front side 206a and a back side 206b and the first adhesive layer 204 can be affixed to the front side of the release layer 206a. As described in more detail below, the release layer 206 can be removed from one or more of the adhesive layers 204, 208 and therefore act as a release agent used to expose the adhesive. The release layer 206 can be made of plastic, such as Mylar, or any material as is known in the art that will not permanently bond to any adhesive layers in the composite form 200. In an modified embodiment, the release layer 206 can be covered with a release coating on one or both sides of the release layer 206 to prevent the adhesive layers 204, 208 from bonding with the release layer 206.

With further reference to FIG. 2, the composite business form 200 can also include the second adhesive layer 208 which can abut the back side of the release layer 206b. As discussed with respect to the first adhesive layer 202, the second adhesive layer 208 can form a permanent adhesive label, or in a modified embodiment, can form a removable adhesive label.

With further reference to FIG. 2, the composite business form 200 can additionally include the backing layer 210 with a front side 210a and a back side 210b which can serve as a substrate material. The backing layer 210 can be attached to the second adhesive layer 208 such that the second adhesive layer 208 is affixed to the front side of the backing layer 210a. The second adhesive layer 208 can be sized such that adhesive covers the entire front surface area of the backing layer 210a. In a modified embodiment, the second adhesive layer 208 can have a surface area that is smaller in width and/or length than the backing layer 210 such that portions of the backing layer 210 do not have any adhesive affixed thereto.

The layers of the composite business form 200 can be formed together under pressure in a press or other device as is known in the art to sandwich the layers together. In one embodiment, through holes can be formed in the composite business form 200 using an air die or punch before or after the layer of material sandwiched together and/or pressed together.

In one embodiment, the composite business form can include a front-side die cut forming an outer peripheral edge 112 and a die cut area 114 lying within the outer peripheral edge as shown in FIG. 1. The die cut area 114 can be printed upon using a standard printer (e.g., household or business) and can additionally include preprinted information. The outer peripheral edge 112 can also include preprinted information. In one embodiment depicted in FIG. 2, the front-side die cut can be cut to a depth such that the cut can extend through the face layer 202 and the first adhesive layer 204, but does not extend through the release layer 206, in order to form an adhesive-backed label within the die cut area. In such an embodiment, the face layer 202 and the first adhesive layer 204 are removably coupled to the release layer 206 such that the face layer 202 and first adhesive layer 204 within the die cut area can be peeled away from the release layer 206 in order to expose the first adhesive layer 204. In yet another embodiment, the front-side die cut can be cut to a depth such that the cut does not pierce the release layer 206. As discussed above, the release layer 206 can be made out of a non-stick material and/or include a release coating to aid in the release of the adhesive layer 204 from the release layer 206 and prevent the first adhesive layer 204 from permanently bonding with the release layer 206. As described above, the exposed first adhesive layer 204 can be a permanent adhesive layer such that the label with adhesive is not intended to be removable after it is affixed to a surface. In alternative embodiments, the exposed first adhesive layer 204 can be minimal residue adhesive such that the label with adhesive can be removed and/or reused on alternate surfaces without leaving noticeable adhesive residue on the original surface.

In another embodiment, the composite business form can include a front-side die cut forming an outer peripheral edge 116 and a die cut area 118 lying within the outer peripheral edge as shown in FIG. 1. The die cut area 118 can be printed upon using a standard printer (e.g., household or business) and can include preprinted information. The outer peripheral edge 116 can also include preprinted information. In one embodiment depicted in FIG. 2, the front-side die cut can be cut to a depth such that the cut can extend through the face layer 202, the first adhesive layer 206, and the release layer 206, but does not extend through the second adhesive layer 208. In such an embodiment, the face layer 202, the first adhesive layer 204, and the release layer 206 are removably coupled with the second adhesive layer 208 such that the outer peripheral edge, when separated from the composite form, exposes the second adhesive layer 208. In such an embodiment, the second adhesive layer 208 forms a front-facing adhesive peripheral edge which can be used as a front-facing adhesive label. Such a label can be placed behind glass, for example, and is visible from the front side of the glass surface. In modified embodiments, the die cut can have a different profile such that the exposed adhesive is not formed on a peripheral edge, but is formed along any portion of the surface. In another embodiment, the front-side die can be cut to a depth such that the cut does not pierce the second adhesive layer 208. The release layer 206 can be made out of a non-stick material and/or include a release coating to aid in the release of the release layer 206 from the second adhesive layer 208 and prevent the release layer 206 from permanently bonding with the second adhesive layer 208. As described above, the exposed second adhesive layer 208 can be a can be minimal residue adhesive such that the label with adhesive can be removed and/or reused on alternate surfaces without leaving noticeable adhesive residue on the original surface. In alternative embodiments, the exposed second adhesive layer 208 can be a permanent adhesive layer such that the label with adhesive is not intended to be removable after it is affixed to a surface.

In yet another embodiment, the composite business form can include a front-side die cut forming an outer peripheral edge 120 and a die cut area 122 lying within the outer peripheral edge as shown in FIG. 1. The die cut area 122 can be printed upon using a standard printer (e.g., household or business) and can include preprinted information. The outer peripheral edge 120 can also include preprinted information. In one embodiment depicted in FIG. 2, the front-side die cut can be cut to a depth such that the cut can extend through the face layer 202, the first adhesive layer 206, and the release layer 206, but does not extend through the second adhesive layer 208. In such an embodiment, the face layer 202, the first adhesive layer 204, and the release layer 206 are removably coupled with the second adhesive layer 208 such that the outer peripheral edge, when separated from the composite form, exposes the second adhesive layer 208. In such an embodiment, the second adhesive layer 208 forms a front-facing adhesive peripheral edge which can be used as a front-facing adhesive label. In modified embodiments, the die cut can have a different profile such that the exposed adhesive is not formed on a peripheral edge, but is formed along any portion of the surface. In another embodiment, the front-side die can be cut to a depth such that the cut does not pierce the second adhesive layer 208. The release layer 206 can be made out of a non-stick material and/or include a release coating to aid in the release of the release layer 206 from the second adhesive layer 208 and prevent the release layer 206 from permanently bonding with the second adhesive layer 208. As described above, the exposed second adhesive layer 208 can be a can be minimal residue adhesive such that the label with adhesive can be removed and/or reused on alternate surfaces without leaving noticeable adhesive residue on the original surface. In alternative embodiments, the exposed second adhesive layer 208 can be a permanent adhesive layer such that the label with adhesive is not intended to be removable after it is affixed to a surface.

FIG. 3 depicts the cross section of a modified embodiment of the composite business form 300. As depicted in FIG. 3, in a modified embodiment, the composite business form 300 can include a front face 302 which is disposed on top of two or more adhesive sections 304a, 304b. As described with reference to FIG. 2, each adhesive section 304a, 304b can be separately formulated as a permanent adhesive to form permanent adhesive label, or alternatively, can be formulated as a non-permanent adhesive to form a removable adhesive label. In one embodiment, one or more adhesive sections 304a, 304b can be minimal residue adhesive such that the label with adhesive can be removed and/or reused on alternate surfaces without leaving a noticeable adhesive residue on the original surface. In one preferred embodiment, the adhesive sections 304a, 304b can be sized to have the same total width and length as the face layer 302. In an alternative embodiment, the adhesive sections 304a, 304b can have a surface area that is smaller in width and length than the face layer 202 such that portions of the face layer do not have any adhesive affixed thereto. In one embodiment, the adhesive sections 304a, 304b can be sized such that the adhesive sections laterally abut each other. In another embodiment, the adhesive sections 304a, 304b can be sized such that there is a lateral gap in between the adhesive sections. The adhesive sections 304a, 304b can be separately manufactured in the composite business form 300 by a masking procedure to allow adhesive layers to be added to one section of the composite business form 300 and not to other sections.

With further reference to FIG. 3, the composite business form 300 can optionally include a release layer 306. The release layer 306 can have a front side 306a and a back side 306b and one of the adhesive sections 304b can be affixed to the back side of the release layer 306b. The release layer 306 can be removably coupled with an adhesive section 304b and therefore act as a release agent used to expose the adhesive. The release layer 306 can be made of plastic, such as Mylar, or any material as is known in the art that will not permanently bond to any adhesive layers in the composite form. In an alternative embodiment, the release layer 306 can be covered with a release coating to prevent the adhesive section 304b from bonding with the release layer 306.

With further reference to FIG. 3, the composite business form 300 can additionally include a backing layer 308 with a front side 308a and a back side 308b and can serve as a substrate material. The backing layer 308 can be attached to the adhesive sections 304a, 304b such that the adhesive sections 304a, 304b are affixed to the front side of the backing layer 308a. The backing layer 308 can be made of plastic, such as Mylar, or any material as is known in the art that will not permanently bond to any adhesive layers in the composite form 300.

As depicted with reference to FIG. 1, in one embodiment, the composite business form can include a front-side die cut forming an outer peripheral edge 112 and a die cut area 114 lying within the outer peripheral edge as shown in FIG. 1. In another embodiment depicted in FIG. 3, the front-side die cut can be cut to a depth such that the cut can extend through the face layer 302 and the adhesive section 304a, but does not extend through the backing layer 308, in order to form an adhesive-backed label within the die cut area. In such an embodiment, the face layer 302 and the adhesive section 304a are removably coupled to the backing layer 308 such that the face layer 302 and adhesive section 304a within the die cut area can be peeled away from the backing layer 308 in order to expose the adhesive section 304a. In yet another embodiment, the front-side die cut can be cut to a depth such that the cut does not pierce the backing layer 308. The exposed adhesive section 304a can be a permanent adhesive or a non-permanent minimal residue adhesive as described above.

As depicted with reference to FIG. 1, in another embodiment, the composite business form can include a front-side die cut forming an outer peripheral edge 116 and a die cut area 118 lying within the outer peripheral edge as shown in FIG. 1. In one embodiment depicted in FIG. 3, the front-side die cut can be cut to a depth such that the cut can extend through the face layer 302, but does not extend through the adhesive section 304a. In such an embodiment, the face layer 302 is removably coupled with the adhesive section 304a such that the outer peripheral edge, when separated from the composite form, exposes the adhesive section 304a. In such an embodiment, the adhesive section 304a forms a front-facing adhesive edge which can be used as a front-facing adhesive label. In another embodiment, the front-side die can be cut to a depth such that the cut does not pierce the adhesive section 304a. In yet another embodiment, the composite business form 300 can optionally include a release layer 306 as discussed above. The front-side die cut can be cut to a depth such that the cut can extend through the face layer 302 and the release layer 306, but does not extend through the adhesive section 304b. In another embodiment, the front-side die cut can be cut to a depth such that the cut does not pierce the adhesive section 304b. Thus, the optional release layer 306 can be used to aid in the removal of the face layer 302 from the adhesive 304b. The exposed adhesive sections 304a, 304b can be a permanent adhesive or a non-permanent minimal residue adhesive as described above.

As further depicted with reference to FIG. 1, in another embodiment, the composite business form can include a front-side die cut forming an outer peripheral edge 120 and a die cut area 122 lying within the outer peripheral edge as shown in FIG. 1. In one embodiment depicted in FIG. 3, the front-side die cut can be cut to a depth such that the cut can extend through the face layer 302, but does not extend through the adhesive section 304a. In such an embodiment, the face layer 302 is removably coupled with the adhesive section 304a such that the outer peripheral edge, when separated from the composite form, exposes the adhesive section 304a. In such an embodiment, the adhesive section 304a forms a front-facing adhesive edge which can be used as a front-facing adhesive label. In another embodiment, the front-side die can be cut to a depth such that the cut does not pierce the adhesive section 304a. In yet another embodiment, the composite business form 300 can optionally include a release layer 306 as discussed above. The front-side die cut can be cut to a depth such that the cut can extend through the face layer 302 and the release layer 306, but does not extend through the adhesive section 304b. In another embodiment, the front-side die cut can be cut to a depth such that the cut does not pierce the adhesive section 304b. Thus, the optional release layer 306 can be used to aid in the removal of the face layer 302 from the adhesive 304b. The exposed adhesive sections 304a, 304b can be a permanent adhesive or a non-permanent minimal residue adhesive as described above.

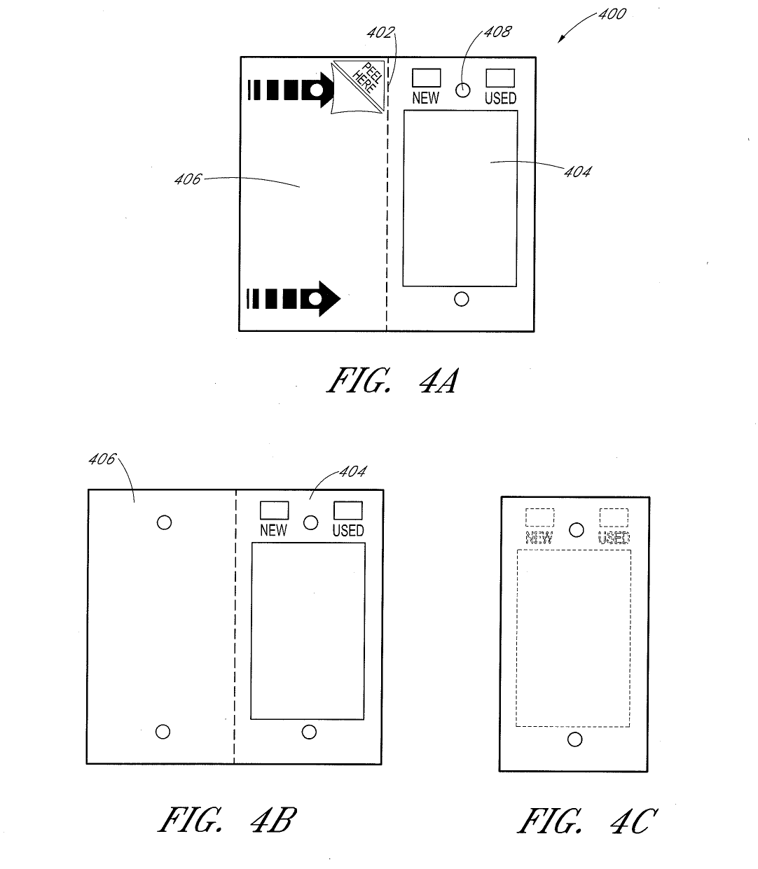

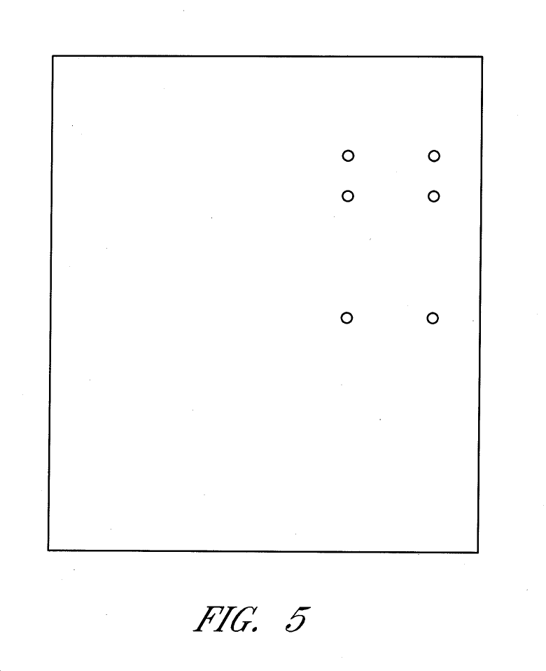

FIGS. 4A-4C depict views of a tag 400 portion of the composite business form according to one preferred embodiment. As illustrated in FIG. 4A, in one embodiment the tag can include a front-side die cut 402 forming a die cut area 404 and a flap 406. In the illustrated embodiment, the front-side die cut 402 is shown as a vertical perforation, however it should be appreciated that the front-side die cut 402 can be oriented in any direction. The die cut area 404 can include a printable section on the front face that can be printed upon using, for example, a common household printer and can include preprinted information. The flap 406 can also include preprinted information on the front face. The tag can include a plurality of layers as depicted in reference to FIG. 2 and FIG. 3. Through holes 408 can be formed in the tag 400 using an air punch or die. In one preferred embodiment, the tag can include a front face, a first adhesive layer, a release layer, a second adhesive layer, and a backing layer, as depicted in reference to FIG. 2. In one embodiment, the front-side die cut can be cut to a depth such that the cut can extend through the face layer 202, the first adhesive layer 204, and the release layer 206, but does not extend through the second adhesive layer 208 as depicted in FIG. 2. In such an embodiment, the face layer 202, the first adhesive layer 204, and the release layer 206 are removably coupled with the second adhesive layer 208 such that the second adhesive layer 208 is exposed on the flap 406 when the face layer 202, first adhesive layer 204, and release layer 206 are removed. In an alternative embodiment, the front-side die cut can be cut to a depth such that the cut does not pierce the second adhesive layer 208. FIG. 4B depicts the exposed adhesive on the flap 406 with the face layer, first adhesive layer and release layers removed. As depicted in FIG. 2B, the adhesive and backing layer can be made out of a clear or transparent material. Once removed, the exposed adhesive flap can be folded on top of the die cut area 404 to form a water-resistant tag as depicted in FIG. 4C.

In an alternative embodiment, the tag can include a front face 302, an adhesive layer 304a, and a backing layer 308 as depicted in reference to FIG. 3. In such an embodiment, the adhesive layer 304a can be exposed by removing the layers formed by a die cut which cuts through the face layer 302, but does not cut through the adhesive layer 304a. In yet another embodiment, the adhesive layer 304a can be exposed by removing the layers formed by a die cut which cuts through the face layer 302, but does not pierce the adhesive layer 304a. In yet another embodiment, the tag can include a front face 302, a release layer 306, an adhesive layer 304b, and a backing layer 308, as depicted in reference to FIG. 3. In such an embodiment, the adhesive layer 304b can be exposed by removing the layers formed by a die cut which cuts through the face layer 302 and the release layer 306 but does not cut through the adhesive layer 304b. In yet another embodiment, the adhesive layer can be exposed by removing the layers formed by a die cut which cuts through the face layer 302 and the release layer 306 but does not pierce the adhesive layer 304b. Once removed, the exposed adhesive flap can be folded on top of the die cut area 404 to form a water-resistant tag as depicted in FIG. 4C.

FIG. 5 depicts a back view of the composite business form according to one preferred embodiment. As shown in FIG. 5, the backing layer can be made out of a transparent or clear material.

In one embodiment, the composite business form can be a vehicle identification label for automobile dealers. The composite business form can have a plurality of separable labels with adhesive and can be packaged on a single 8.5×11 sheet. The composite business form 100 can be printed on using a standard printer (e.g., household or business) such as an inkjet printer, laser printer, or any other printer as is known in the art. The composite business form can include a software database and printer template for organizing and storing vehicle information. In one embodiment, the composite business form can include five labels including a deal jacket label 102, an inside window vehicle specification 104a, a stock window sticker 104b, and two key tag labels 106a, 106b as shown in FIG. 1. It should be appreciated that the composite business form can include a different number of labels.

In one embodiment, the composite business form 100 can include a deal jacket label 102. The deal jacket label can be used to identify and coordinate a vehicle's paper-based file. The deal jacket label 102 can be designed as peel-able adhesive backed label as described in reference to the arrangements in FIGS. 2 and 3 and can be placed on a vehicle's information folder. In such an embodiment, the adhesive backed label can be a permanent adhesive label, as described above, such that the label is not substantially removable from the vehicle's information folder.

In another embodiment, the composite business form 100 can include an inside window vehicle specification 104a. The inside window vehicle specification can include information such as the details of the car specifics and pricing information. The inside window vehicle specification 104a can be designed as a label to be placed on the inside of the window of a vehicle facing the exterior of the vehicle. As described in reference to the arrangements in FIGS. 2 and 3, the outer peripheral edge of the face of the inside window vehicle specification 104a can have a peel-off portion which exposes the front-facing adhesive layer underneath. Once the adhesive is exposed, the inside window vehicle specification 104b can be placed inside of a window facing the exterior of the vehicle to display vehicle specifics. In such an embodiment, the exposed adhesive can be minimal residue adhesive such that the inside window vehicle specification 104a can be removed from a vehicle's window and/or reused on alternate surfaces without leaving noticeable adhesive residue on the vehicle's window.

In yet another embodiment, the composite business form 100 can include a stock window sticker 104b. The stock window sticker 104b can include information such as the stock number of the vehicle and other identifying information. The stock window sticker 104b can be designed as a label to be placed on the inside of the window of a vehicle facing the exterior of the vehicle. As described in reference to the arrangements in FIGS. 2 and 3, the outer peripheral edge of the face of the stock window sticker 104b can have a peel-off portion which exposes the front-facing adhesive layer underneath. Once the adhesive is exposed, the stock window sticker 104b can be placed inside of a window facing the exterior of the vehicle to display vehicle specifics. In such an embodiment, the adhesive backed label can be a permanent adhesive label, as described above, such that the label is not substantially removable from the vehicle's information folder. In such an embodiment, the exposed adhesive can be minimal residue adhesive such that the stock window sticker can be removed from a vehicle's window and/or reused on alternate surfaces without leaving noticeable adhesive residue on the vehicle's window.

In yet a further arrangement, the composite business form 100 can include one or more key tags 106a, 106b. The key tags can be waterproof tags designed to be placed on the key ring of the vehicle. As described in reference to FIG. 4, a portion of the face of the key tag label can have a peel-off portion to expose a clear plastic substrate layer with adhesive on front of the substrate. The clear plastic substrate layer can be folded and placed on top of the face portion forming a laminated, waterproof tag. The terms “approximately”, “about”, and “substantially” as used herein represent an amount or characteristic close to the stated amount or characteristic that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount or characteristic. The term “up to about” as used herein has its ordinary meaning as known to those skilled in the art and may include 0 wt. %, minimum or trace wt. %, the given wt. %, and all wt. % in between.

The specific dimensions of any of the embodiment disclosed herein can be readily varied depending upon the intended application, as will be apparent to those of skill in the art in view of the disclosure herein. Moreover, although the present inventions have been described in terms of certain preferred embodiments, other embodiments of the inventions including variations in the number of parts, dimensions, configuration and materials will be apparent to those of skill in the art in view of the disclosure herein. In addition, all features discussed in connection with any one embodiment herein can be readily adapted for use in other embodiments herein to form various combinations and sub-combinations. The use of different terms or reference numerals for similar features in different embodiments does not imply differences other than those which may be expressly set forth. Accordingly, the present inventions are intended to be described solely by reference to the appended claims, and not limited to the preferred embodiments disclosed herein.

What is claimed is:

1. A business form having a laminate composite structure comprising:
a first printable layer of material including a front surface and a back surface, the front surface containing a plurality of printed characters;
a second layer contacting the back surface of said first printable layer;
a third layer including a front surface and a back surface; the front surface of the third layer contacting the second layer and releasably coupled to the second layer;
a fourth layer contacting the back surface of said third layer and releasably coupled to the third layer; and
a fifth layer including a front surface and a back surface, the front surface of the fifth layer contacting the fourth layer;
wherein said first printable layer includes at least one first front-side die cut such that the composite business form is separable into at least two portions.

2. The business form of claim 1, wherein the second layer is a first adhesive layer.

3. The business form of claim 1, wherein the third layer is a first backing layer.

4. The business form of claim 1, wherein the fourth layer is a second adhesive layer.

5. The business form of claim 1, wherein the fifth layer is a second backing layer.

6. The business form of claim 1, wherein said first printable layer includes at least one first front-side die cut that extends through the second layer but does not extend through the third layer such that the second layer is released from the third layer.

7. The business form of claim 1, wherein said first printable layer includes at least one first front-side die cut that extends through the third layer but does not extend through the fourth layer such that the third layer is released from the fourth layer.

8. A method for creating a business form having a laminate composite structure comprising:
providing a first printable layer of material including a front surface and a back surface, the front surface readily printable;
providing a second layer contacting the back surface of said first printable layer;
providing a third layer including a front surface and a back surface; the front surface of the third layer contacting the second layer and releasably coupled to the second layer;
providing a fourth layer contacting the back surface of said third layer and releasably coupled to the third layer; and
providing a fifth layer including a front surface and a back surface, the front surface of the fifth layer contacting the fourth layer;
pressing the first through fifth layers together to form a composite; and
adding at least one first front-side die cut such that the composite business form is separable into at least two portions.

9. The method of claim 8, wherein the second layer is a first adhesive layer.

10. The method of claim 8, wherein the third layer is a first backing layer.

11. The method of claim 8, wherein the fourth layer is a second adhesive layer.

12. The method of claim 8, wherein the fifth layer is a second backing layer.

13. The method of claim 8, including a second front-side die cut wherein said second front-side die cut that extends through the second layer but does not extend through the third layer such that the second layer is releasable from the third layer.

14. The method of claim 8, including a second front-side die cut wherein said second front-side die cut extends through the third layer but does not extend through the fourth layer such that the third layer is releasable from the fourth layer.

15. A business form having a laminate composite structure comprising:
at least one printable layer of material wherein said printable layer includes at least one front-side die cut such that the composite business form is separable into at least a first portion and a second portion;
wherein said first portion includes
at least one adhesive layer at least one layer below said printable layer;
at least one backing layer at least one layer below said printable layer;
at least one front-side die cut on said first portion forming a first outer peripheral edge and a first die cut area lying within the first outer peripheral edge;
wherein said first die cut area of the printable layer is releasably coupled to the at least one backing layer of the first portion such that the first die cut area of the printable layer and the at least one adhesive layer of the first portion when separated from the at least one backing layer form an adhesive-backed label; and
wherein said second portion includes
at least one adhesive layer at least one layer below said printable layer;
at least one backing layer at least one layer below said printable layer;
at least one front-side die cut on said second portion forming a second outer peripheral edge and a second die cut area lying within the first outer peripheral edge;
wherein said second outer peripheral edge of the printable layer is releasably coupled to the at least one backing layer of the second portion such that the outer peripheral edge of the printable layer when separated from the composite form exposes the at least one adhesive layer of said section portion.

16. The business form of claim 15, including a third portion wherein said third portion includes
at least one adhesive layer at least one layer below said printable layer;
at least one backing layer at least one layer below said printable layer; and
at least one front-side die cut on said third portion forming a flap and a third die cut area adjacent the flap;
wherein said flap of the printable layer is releasably coupled to the at least one backing layer of the third portion such that the flap when separated from the composite form exposes the at least one adhesive layer of said third portion which can be folded over the third die cut area to form a sealed tag.

17. A business form having a laminate composite structure comprising:
At least one printable layer of material wherein said first printable layer includes at least one front-side die cut such that the composite business form is separable into at least a first portion and a second portion;
wherein said first portion includes
a first adhesive layer at least one layer below said first printable layer;
a first backing layer at least one layer below said first printable layer;
at least one front-side die cut on said first portion forming a first outer peripheral edge and a first die cut area lying within the first outer peripheral edge;
wherein said first die cut area of the first printable layer is releasably coupled to the first backing layer of the first portion such that the die cut area of the first printable layer and the first adhesive layer of the first portion when separated from the first backing layer forms an adhesive-backed label; and
wherein said second portion includes
a second adhesive layer at least one layer below said first printable layer;
a second backing layer at least one layer below said first printable layer;
at least one front-side die cut on said second portion forming a second outer peripheral edge and a second die cut area lying within the second outer peripheral edge;
wherein said second outer peripheral edge of the printable layer is releasably coupled to the second backing layer of the second portion such that the second outer peripheral edge of the printable layer when separated from the composite form exposes the second adhesive layer of said section portion.

18. The business form of claim 17, wherein said first adhesive layer is a permanent adhesive such that the adhesive-backed label is substantially permanent after the label is affixed to a surface.

19. The business form of claim 17, wherein said second adhesive layer is a non-permanent minimal residue adhesive, such that the section portion is removable after the second portion is affixed to a surface and leaves minimal adhesive residue after removed from a surface.

20. A business form having a laminate composite structure comprising:
At least one printable layer of material wherein said printable layer includes at least one front-side die cut such that the composite business form is separable into at least a first portion and a second portion;
wherein said first portion includes
a first adhesive layer at least one layer below said printable layer;
a first backing layer at least one layer below said printable layer;
at least one front-side die cut on said first portion forming a first outer peripheral edge and a first die cut area lying within the first outer peripheral edge;
wherein said first portion includes at least one first front-side die cut that extends through the printable layer and first adhesive layer but does not extend through the first backing layer such that printable layer and first adhesive layer are releasably coupled to the first backing layer and when separated from the first backing layer forms an adhesive-backed label; and
wherein said second portion includes
a second adhesive layer at least one layer below said printable layer;
a second backing layer at least one layer below said printable layer;
at least one front-side die cut on said second portion forming a second outer peripheral edge and a second die cut area lying within the second outer peripheral edge;
wherein said second portion includes at least one first front-side die cut that extends through the second printable layer but does not extend through the second adhesive layer or second backing layer such that printable layer is releasably coupled to the second adhesive layer and second backing layer such that the outer peripheral edge when separated from the composite form exposes the second adhesive layer of said section portion.
